(19) United States
(12) Patent Application Publication
(10) Pub. No.: US 2013/0063556 A1
(43) Pub. Date: Mar. 14, 2013

(54) EXTRACTING DEPTH INFORMATION FROM VIDEO FROM A SINGLE CAMERA

(71) Applicants: Steve Russell, San Francisco, CA (US); Ron Palmeri, San Francisco, CA (US); Robert Cutting, San Francisco, CA (US); Doug Johnston, San Francisco, CA (US); Mike Fogel, San Francisco, CA (US); Robert Cosgriff, San Francisco, CA (US)

(72) Inventors: Steve Russell, San Francisco, CA (US); Ron Palmeri, San Francisco, CA (US); Robert Cutting, San Francisco, CA (US); Doug Johnston, San Francisco, CA (US); Mike Fogel, San Francisco, CA (US); Robert Cosgriff, San Francisco, CA (US)

(73) Assignee: PRISM SKYLABS, INC., San Francisco, CA (US)

(21) Appl. No.: 13/607,571

(22) Filed: Sep. 7, 2012

Related U.S. Application Data
(60) Provisional application No. 61/532,205, filed on Sep. 8, 2011.

(51) Int. Cl. H04N 13/00

(52) U.S. Cl. 348/42; 348/E13.001

(57) ABSTRACT

Techniques are provided for generating depth estimates for pixels, in a series of images captured by a single camera, that correspond to the static objects. The techniques involve identifying occlusion events in the series of images. The occlusion events are events in which dynamic blobs are at least partially occluded, by static objects, from view of the camera. The depth estimates for pixels of the static objects are generated based on the occlusion events and depth estimates associated with the dynamic blobs. Techniques are also provided for generating the depth estimates associated with the dynamic blobs. The depth estimates for the dynamic blobs are generated based on how far down, within at least one image, the lowest point of the dynamic blob is located.

### CROSS-REFERENCE TO RELATED APPLICATIONS; BENEFIT CLAIM

This application claims the benefit of Provisional Appln. 61/532,205, filed Sep. 8, 2011, entitled “Video Synthesis System”, the entire contents of which is hereby incorporated by reference as if fully set forth herein, under 35 U.S.C. §119(e).

### FIELD OF THE INVENTION

The present invention relates to extracting depth information from video and, more specifically, extracting depth information from video from a single camera.

### BACKGROUND

Typical video cameras record, in two-dimensions, the images of objects that exist in three dimensions. When viewing a two-dimensional video, the images of all objects are approximately the same distance from the viewer. Nevertheless, the human mind generally perceives some objects depicted in the video as being closer (foreground objects) and other objects in the video as being further away (background objects).

While the human mind is capable of perceiving the relative depths of objects depicted in a two-dimensional video display, it has proven difficult to automate that process. Performing accurate automated depth determinations on two-dimensional video content is critical to a variety of tasks. In particular, in any situation where the quantity of video to be analyzed is substantial, it is inefficient and expensive to have the analysis performed by humans. For example, it would be both tedious and expensive to employ humans to constantly view and analyze continuous video feeds from surveillance cameras. In addition, while humans can perceive depth almost instantaneously, it would be difficult for the humans to convey their depth perceptions back into a system that is designed to act upon those depth determinations in real-time.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIGS. 1A and 1B are block diagrams illustrating images captured by a single camera;

FIGS. 2A and 2B are block diagrams illustrating dynamic blobs detected within the images depicted in FIGS. 1A and 1B;

FIG. 3 is a flowchart illustrating steps for automatically estimating depth values for pixels in images from a single camera, according to an embodiment of the invention; and

FIG. 4 is a block diagram of a computer system upon which embodiments of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Techniques to extract depth information from video produced by a single camera are described herein. In one embodiment, the techniques are able to ingest video frames from a camera sensor or compressed video output stream and determine depth of vision information within the camera view for foreground and background objects.

In one embodiment, rather than merely applying simple foreground/background binary labeling to objects in the video, the techniques assign a distance estimate to pixels in the frame in the image sequence. Specifically, when using a fixed orientation camera, the view frustum remains fixed in 3D space. Each pixel on the image plane can be mapped to a ray in the frustum Assuming that in the steady state of a scene, much of the scene remains constant, a model can be created which determines, for each pixel at a given time, whether or not the pixel matches the steady state value(s) for that pixel, or whether it is different. The former are referred to herein as background, and the latter foreground. Based on the FG/BG state of a pixel, its state relative to its neighbors, and its relative position in the image, an estimate is made of the relative depth in the view frustum of objects in the scene, and their corresponding pixels on the image plane.

Utilizing the background model to segment foreground activity, and extracting salient image features from foreground (for understanding level of occlusion of body parts), a ground plane for the scene can be statistically estimated. Then once aggregated, pedestrians or other moving objects (possibly partially occluded) can be used to statistically learn an effective floor plan. This effective floor plan allows for an estimation of a rigid geometric model of the scene, by a projection on the ground plane, as well the available pedestrian data. This rigid geometry of a scene can be leveraged to assign a stronger estimation to the relative depth information utilized in the learning phase, as well as future data.

### Example Process

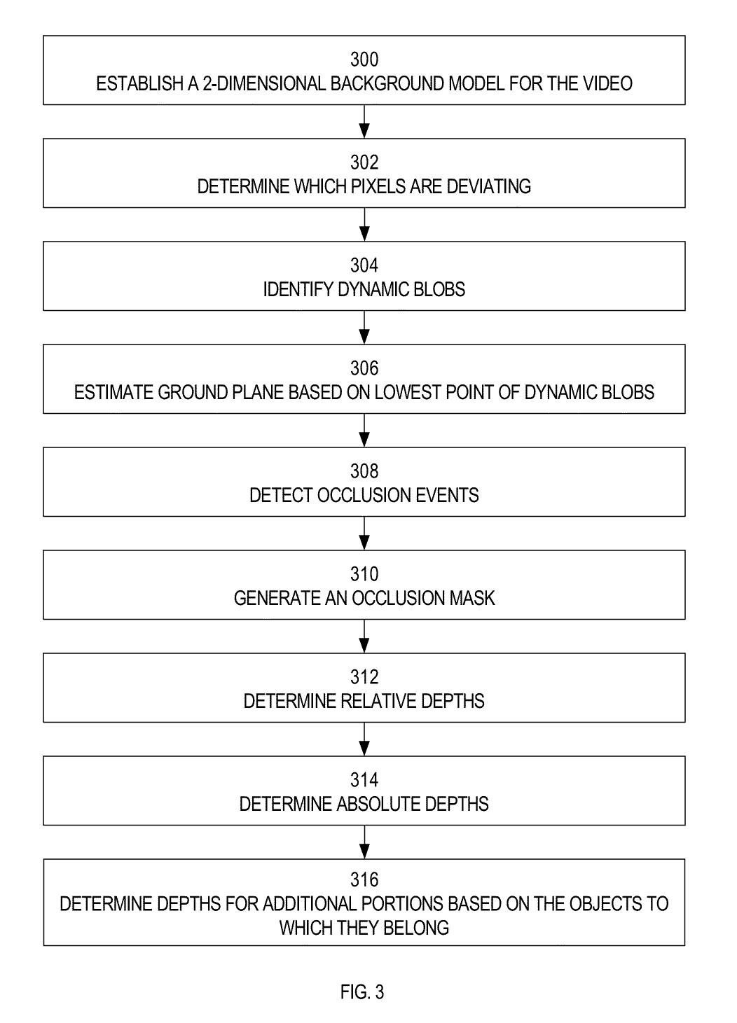

FIG. 3 is a flowchart that illustrates general steps for assigning depth values to content within video, according to an embodiment of the invention. Referring to FIG. 3, at step 300, a 2-dimensional background model is established for the video. The 2-dimensional background model indicates, for each pixel, what color space the pixel typically has in a steady state.

At step 302, the pixel colors of images in the video are compared against the background model to determine which pixels, in any given frame, are deviating from their respective color spaces specified in the background model. Such deviations are typically produced when the video contains moving objects.

At step 304, the boundaries of moving objects (“dynamic blobs”) are identified based on how the pixel colors in the images deviate from the background model.

At step 306, the ground plane is estimated based on the lowest point of each dynamic blob. Specifically, it is assumed that dynamic blobs are in contact with the ground plane (as opposed to flying), so the lowest point of a dynamic blob (e.g. the bottom of the shoe of a person in the image) is assumed to be in contact with the ground plane.

At step 308, the occlusion events are detected within the video. An occlusion event occurs when only part of a dynamic blob appears in a video frame. The fact that a dynamic blob is only partially visible in a video frame may be detected, for example, by a significant decrease in the size of the dynamic blob within the captured images.

At step 310, an occlusion mask is generated based on where the occlusion events occurred. The occlusion mask indicates which portions of the image are able to occlude dynamic blobs, and which portions of the image are occluded by dynamic blobs.

At step 312, relative depths are determined for portions of an image based on the occlusion mask.

At step 314, absolute depths are determined for portions of the image based on the relative depths and actual measurement data. The actual measurement data may be, for example, the height of a person depicted in the video.

At step 316, absolute depths are determined for additional portions of the image based on the static objects those additional portions belong, and the depth values that were established for those objects in step 314.

Each of these steps shall be described hereafter in greater detail.

### Building a Background Model

As mentioned above, a 2-dimensional background model is built based on the “steady-state” color space of each pixel captured by a camera. In this context, the steady-state color space of a given pixel generally represents the color of the static object whose color is captured by the pixel. Thus, the background model estimates what color (or color range) every pixel would have if all dynamic objects were removed from the scene captured by the video.

Various approaches may be used to generate a background model for a video, and the techniques described herein are not limited to any particular approach for generating a background model. Examples of approaches for generating background models may be found, for example, in Z. Zivkovic, Improved adaptive Gausian mixture model for background subtraction, International Pattern Recognition, UK, August, 2004.

### Identifying Dynamic Blobs

Once a background model has been generated for the video, the images from the camera feed may be compared to the background model to identify which pixels are deviating from the background model. Specifically, for a given frame, if the color of a pixel falls outside the color space specified for that pixel in the background model, the pixel is considered to be a “deviating pixel” relative to that frame.

Deviating pixels may occur for a variety of reasons. For example, a deviating pixel may occur because of static or noise in the video feed. On the other hand, a deviating pixel may occur because a dynamic blob passed between the camera and the static object that is normally captured by that pixel. Consequently, after the deviating pixels are identified, it must be determined which deviating pixels were caused by dynamic blobs.

A variety of techniques may be used to distinguish the deviating pixels caused by dynamic blobs from those deviating pixels that occur for some other reason. For example, according to one embodiment, an image segmentation algorithm may be used to determine candidate object boundaries. Any one of a number of image segmentation algorithms may be used, and the depth detection techniques described herein are not limited to any particular image segmentation algorithm. Example image segmentation algorithms that may be used to identify candidate object boundaries are described, for example, in Jianbo Shi and Jitendra Malik. 1997. Normalized Cuts and Image Segmentation. In Proceedings of the 1997 Conference on Computer Vision and Pattern Recognition (CVPR '97). IEEE Computer Society, Washington, D.C., USA, 731-

Once the boundaries of candidate objects have been identified, a connected component analysis may be run to determine which candidate blobs are in fact dynamic blobs. In general, connected component analysis algorithms are based on the notion that, when neighboring pixels are both determined to be foreground (i.e. deviating pixels caused by a dynamic blob), they are assumed to be part of the same physical object. Example connected component analysis techniques are described in Yujie Han and Robert A. Wagner. 1990. An efficient and fast parallel-connected component algorithm. J. ACM 37, 3 (July 1990), 626-642. DOI=10.1145/79147.214077 http://doi.acm.org/10.1145/79147.214077. However, the depth detection techniques described herein are not limited to any particular connected component analysis technique.

### Tracking Dynamic Blobs

According to one embodiment, after connected component analysis is performed to determine dynamic blobs, the dynamic blob information is fed to an object tracker that tracks the movement of the blobs through the video. According to one embodiment, the object tracker runs an optical flow algorithm on the images of the video to help determine the relative 2d motion of the dynamic blobs. Optical flow algorithms are explained, for example, in B. Lucas and T. Kanade. An iterative image registration technique with an application to stereo vision. In Proc. Seventh International Joint Conference on Artificial Intelligence, pages 674-679, Vancouver, Canada, Aug. 1981. However, the depth detection techniques described herein are not limited to any particular optical flow algorithm.

The velocity estimation provided by the optical flow algorithm of pixels contained within an object blob are combined to derive an estimation of the overall object velocity, and used by the object tracker to predict object motion from frame to frame. This is used in conjunction with tradition spatial-temporal filtering methods, and is referred to herein as object tracking. For example, based on the output of the optical flow algorithm, the object tracker may determine that an elevator door that periodically opens and closes (thereby producing deviating pixels) is not an active foreground object, while a person walking around a room is. Object tracking techniques are described, for example, in Sangho Park and J. K. Aggarwal. 2002. Segmentation and Tracking of Interacting Human Body Partns under Occlusion and Shadowing. In Proceedings of the Workshop on Motion and Video Computing (MOTION '02). IEEE Computer Society, Washington, D.C., USA, 105-.

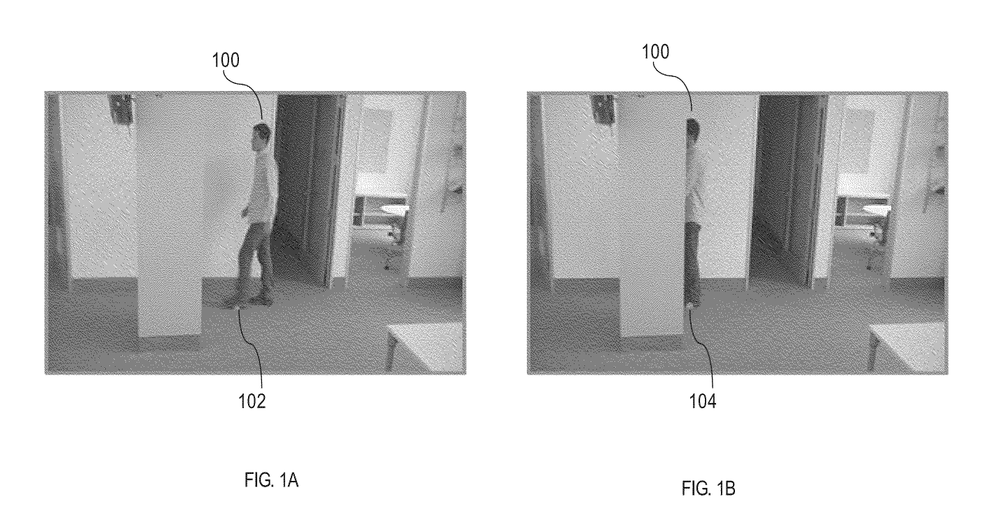

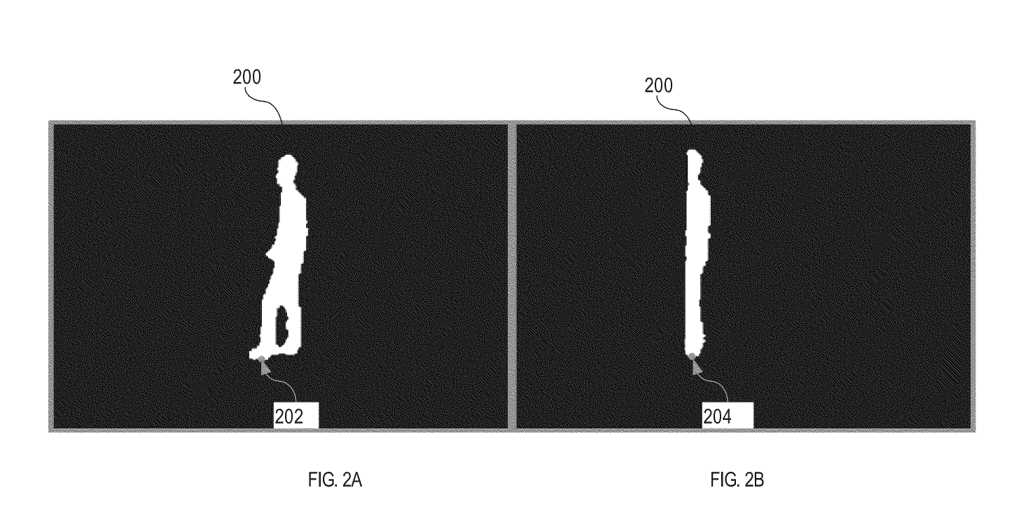

Referring to FIGS. 1A and 1B, they illustrate images captured by a camera. In the images, all objects are stationary with the exception of a person 100 that is walking through the room. Because person 100 is moving, the pixels that capture person 100 in FIG. 1A are different than the pixels that capture person 100 in FIG. 1B. Consequently, those pixels will be changing color from frame to frame. Based on the image segmentation and connected component analysis, person 100 will be identified as a dynamic blob 200, as illustrated in FIGS. 2A and 2B. Further, based on the optical flow algorithm, the object tracker determines that dynamic blob 200 in FIG. 2A is the same dynamic blob as dynamic blob 200 in FIG. 2B.

### Ground Plane Estimation

According to one embodiment, the dynamic blob information produced by the object tracker is used to estimate the ground plane within the images of a video. Specifically, in one embodiment, the ground plane is estimated based on both the dynamic blob information and data that indicates the “down” direction in the images. The “down-indicating” data may be, for example, a 2d vector that specifies the down direction of the world depicted in the video. Typically, this is perpendicular to the bottom edge of the image plane. The down-indicating data may be provided by a user, provided by the camera, or extrapolated from the video itself. The depth estimating techniques described herein are not limited to any particular way of obtaining the down-indicating data.

Given the down-indicating data, the ground plane is estimated based on the assumption that dynamic objects that are contained entirely inside the view frustum will intersect with the ground plane inside the image area. That is, it is assumed that the lowest part of a dynamic blob will be touching the floor.

The intersection point is defined as the maximal 2d point of the set of points in the foreground object, projected along the normalized down direction vector. Referring again to FIGS. 1A and 1B, the lowest point of person 100 is point 102 in FIG. 1A, and point 104 in FIG. 1B. From the dynamic blob data, points 102 and 104 show up as points 202 and 204 in FIGS. 2A and 2B, respectively. These intersection points are then fitted to the ground plane model using standard techniques robust to outliers, such a RANSAC, or J-Linkage, using the relative ordering of these intersections as a proxy for depth. Thus, the higher the lowest point of a dynamic blob, the greater the distance of the dynamic blob from the camera, and the greater the depth value assigned to the image region occupied by the dynamic blob.

### Occlusion Mask

When a dynamic blob partially moves behind a stationary object in the scene, the blob will appear to be cut off, with an exterior edge of the blob along the point of intersection of the stationary object, as seen from the camera. Consequently, the pixel-mass of the dynamic blob, which remains relatively constant while the dynamic blob is in full view of the camera, significantly decreases. This is the case, for example, in FIGS. 1B and 2B. Instances where dynamic blobs are partially or entirely occluded by stationary objects are referred to herein as occlusion events.

A variety of mechanisms may be used to identify occlusion events. For example, in one embodiment, the exterior gradients of foreground blobs are aggregated into a statistical model for each blob. These aggregated statistics are then used as an un-normalized measure (i.e. Mahalanobis distance) of the probability that the pixel represents the edge statistics of an occluding object. Over time, the aggregated sum reveals the location of occluding, static objects. Data that identifies the locations of objects that, at some point in the video, have occluded a dynamic blob, is referred to herein as the occlusion mask.

Typically, at the point that a dynamic blob is occluded, a relative estimate of where the tracked object is on the ground plane has already been determined, using the techniques described above. Consequently, a relative depth determination can be made about the point at which the tracked object overlaps the high probability areas in the occlusion mask. Specifically, in one embodiment, if the point at which a tracked object intersects an occlusion mask pixel is also an edge pixel in the tracked object, then the pixel is assigned a relative depth value that is closer to the camera than the dynamic object being tracked. If it is not an edge pixel, then the pixel is assigned a relative depth value that is further from the camera than the object being tracked.

For example, in FIG. 2B, the edge produced by the intersection of the pillar and the dynamic blob 200 is an edge pixel of dynamic blob 200. Consequently, part of dynamic blob 200 is occluded. Based on this occlusion event, it is determined that, the static object that is causing the occlusion event is closer to the camera than dynamic blob 200 in FIG. 2B (i.e. the depth represented by point 204). On the other hand, dynamic blob 200 in FIG. 2A is not occluded, and is covering the pixels that represent the pillar in the occlusion mask. Consequently, it may be determined that the pillar is further from the camera than dynamic blob 200 in FIG. 2A (i.e. the depth represented by point 202).

According to one embodiment, these relative depths are built up over time to provide a relative depth map by iterating between ground plane estimation and updating the occlusion mask.

### Determining Actual Depth

Size cues, such as person height, distance between eyes in identified faces, or user provided measurements can convert the relative depths to absolute depths given a calibrated camera. For example, given the height of person 100, the actual depth of points 202 and 204 may be estimated. Based on these estimates and the relative depths determined based on occlusion events, the depth of static occluding objects may also be estimated.

### Propagating Depth Values

Typically, not every pixel will be involved in an occlusion event. For example, during the period covered by the video, people may pass behind one portion of an object, but not another portion. Consequently, the relative and/or actual depth values may be estimated for the pixels that correspond to the portions of the object involved in the occlusion events, but not the pixels that correspond to other portions of the object.

According to one embodiment, depth values that are assigned to pixels for which depth estimates are generated are used to determine depth estimates for other pixels. For example, various techniques may be used to determine the boundaries of fixed objects. For example, if a certain color texture covers a particular region of the image, it may be determined that all pixels belonging to that particular region correspond to the same static object.

Based on a determination that pixels in a particular region all correspond to the same static object, depth values estimated for some of the pixels in the region may be propagated to other pixels in the same region.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

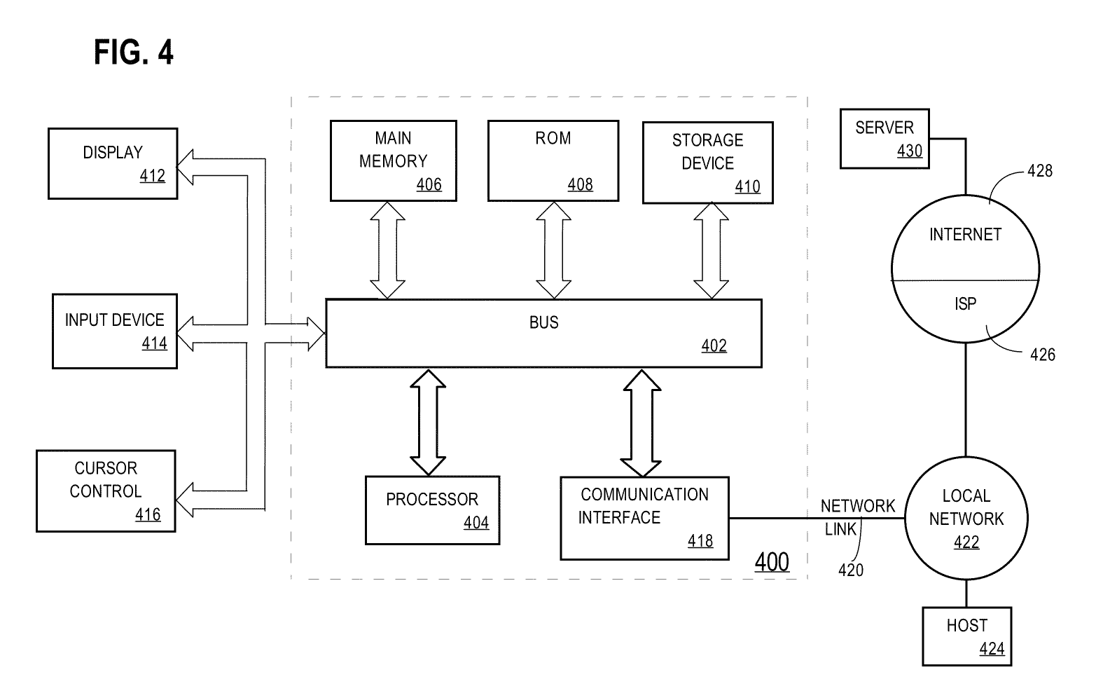

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, optical disk, or solid-state drive is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 410. Volatile media includes dynamic memory, such as main memory 406. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid-state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
identifying occlusion events in a series of images captured by a single camera;
wherein the occlusion events are events in which dynamic blobs are at least partially occluded, by static objects, from view of the camera; and
based on the occlusion events and depth estimates associated with the dynamic blobs, generating depth estimates for pixels, in the series of images, that correspond to the static objects;
wherein the method is performed by one or more computing devices.

2. The method of claim 1 further comprising generating the depth estimates associated with the dynamic blobs by:
obtaining down-indicating data that indicates a down direction for at least one image in the series of images; and
for each of the dynamic blobs, performing the steps of:
based on the down-indicating data, identifying a lowest point of the dynamic blob in the at least one image; and
determining relative depth of the dynamic blob based on how far down, within the at least one image, the lowest point of the dynamic blob is located.

3. The method of claim 1 further comprising generating an occlusion mask based on the occlusion events, wherein the step of depth estimates is based, at least in part, on the occlusion mask.

4. The method of claim 3 wherein the step of generating the occlusion mask includes:
aggregating exterior gradients of the dynamic blobs into a statistical model for each dynamic blob; and
using the aggregated exterior gradients as an un-normalized measure of the probability that pixels represent edge statistics of an occluding object.

5. The method of claim 2 further comprising generating a ground plane estimation based, at least in part, on locations of the lowest points of the dynamic blobs, where the step of generating depth estimates is based, at least in part, on the ground plane estimation.

6. The method of claim 1 wherein:
the step of generating depth estimates includes generated relative depth estimates; and
the method further comprises the steps of:
obtaining size information about an actual size of an object in at least one image of the series of images; and
based on the size information and the relative depth estimates, generating an actual depth estimate for at least one pixel in the series of images.

7. The method of claim 1 further comprising:
determining that both a first pixel and a second pixel, in an image of the series of images, corresponds to a same object; and
generating a depth estimate for the second pixel based on a depth estimate of the first pixel and the determination that the first pixel and the second pixel correspond to the same object.

8. The method of claim 7 wherein determining that both the first pixel and the second pixel correspond to the same object is performed based, at least in part, on at least one of:
colors of the first pixel and the second pixel; and
textures associated with the first and second pixel.

9. One or more non-transitory storage media storing instructions which, when executed by one or more computing devices, cause performance of a method that comprises the steps of:
identifying occlusion events in a series of images captured by a single camera;
wherein the occlusion events are events in which dynamic blobs are at least partially occluded, by static objects, from view of the camera; and
based on the occlusion events and depth estimates associated with the dynamic blobs, generating depth estimates for pixels, in the series of images, that correspond to the static objects.

10. The one or more non-transitory storage media of claim 9 wherein the method further comprises generating the depth estimates associated with the dynamic blobs by:
obtaining down-indicating data that indicates a down direction for at least one image in the series of images; and
for each of the dynamic blobs, performing the steps of:
based on the down-indicating data, identifying a lowest point of the dynamic blob in the at least one image; and
determining relative depth of the dynamic blob based on how far down, within the at least one image, the lowest point of the dynamic blob is located.

11. The one or more non-transitory storage media of claim 9 wherein the method further comprises generating an occlusion mask based on the occlusion events, wherein the step of depth estimates is based, at least in part, on the occlusion mask.

12. The one or more non-transitory storage media of claim 11 wherein the step of generating the occlusion mask includes:
aggregating exterior gradients of the dynamic blobs into a statistical model for each dynamic blob; and
using the aggregated exterior gradients as an un-normalized measure of the probability that pixels represent edge statistics of an occluding object.

13. The one or more non-transitory storage media of claim 10 wherein the method further comprises generating a ground plane estimation based, at least in part, on locations of the lowest points of the dynamic blobs, where the step of generating depth estimates is based, at least in part, on the ground plane estimation.

14. The one or more non-transitory storage media of claim 9 wherein:
the step of generating depth estimates includes generated relative depth estimates; and
the method further comprises the steps of:
obtaining size information about an actual size of an object in at least one image of the plurality of images; and
based on the size information and the relative depth estimates, generating an actual depth estimate for at least one pixel in the series of images.

15. The one or more non-transitory storage media of claim 9 wherein the method further comprises:
determining that both a first pixel and a second pixel, in an image of the plurality of images, corresponds to a same object; and
generating a depth estimate for the second pixel based on a depth estimate of the first pixel and the determination that the first pixel and the second pixel correspond to the same object.

16. The one or more non-transitory storage media of claim 15 wherein determining that both the first pixel and the second pixel correspond to the same object is performed based, at least in part, on at least one of:
colors of the first pixel and the second pixel; and
textures associated with the first and second pixel.

17. A method comprising:
identifying dynamic blobs within a series of images captured by a single camera; and
generating depth estimates associated with the dynamic blobs by:
obtaining down-indicating data that indicates a down direction for at least one image in the series of images; and
for each of the dynamic blobs, performing the steps of:
based on the down-indicating data, identifying a lowest point of the dynamic blob in the at least one image; and
determining relative depth of the dynamic blob based on how far down, within the at least one image, the lowest point of the dynamic blob is located;
wherein the method is performed by one or more computing devices.
